(19) United States
(12) Patent Application Publication
(10) Pub. No.: US 2025/0031738 A1
(43) Pub. Date: Jan. 30, 2025

(54) STABILIZER COMPOSITIONS FOR FILLINGS AND TOPPINGS

(71) Applicant: TATE & LYLE SOLUTIONS USA LLC, Hoffman Estates, IL (US)

(72) Inventors: Yayu Sophia Pai, Hoffman Estates, IL (US); James Walsh, Hoffman Estates, IL (US); Ming Liu, Hoffman Estates, IL (US); Julia DesRochers, Hoffman Estates, IL (US)

(21) Appl. No.: 18/709,189

(22) PCT Filed: Nov. 11, 2022
(86) PCT No.: PCT/US2022/079707

§ 371 Date: May 10, 2024

Related U.S. Application Data
(60) Provisional application No. 63/278,657, filed on Nov. 12, 2021.

(51) Int. Cl. A23L 29/262; A21D 13/28; A21D 13/38; A23J 3/14; A23L 29/10; A23L 29/212

(52) U.S. Cl. CPC A23L 29/262; A21D 13/28; A21D 13/38; A23J 3/14; A23L 29/10; A23L 29/212

(57) ABSTRACT

The disclosure relates generally to stabilizer compositions, food composition suitable for fillings and toppings, methods of making a food composition, methods of making filled or topped food items. In one embodiment, a stabilizer composition includes a heat-settable material present in an amount in the range of 5-30 wt %, starch present in an amount in the range of 25-70 wt %, a plant protein present in an amount in the range of 0.2-50 wt %, and a fiber comprising insoluble fiber, the fiber being present in an amount in the range of 3-30 wt %.

### CROSS-REFERENCE TO RELATED APPLICATIONS

This application claims the benefit of each of U.S. Provisional Patent Application No. 63/278,657, filed Nov. 12, 2021, which is hereby incorporated herein by reference in its entirety.

### BACKGROUND OF THE DISCLOSURE

### Field of the Disclosure

The present disclosure relates generally to stabilizer compositions suitable for bake-stabilizing filings and toppings for foods, food compositions suitable for use as fillings and toppings, methods of making such food compositions, and methods of making filled or topped food items.

### Technical Background

In ready-to-eat foods, oil- or fat-containing filling and toppings are commonly used to provide texture and flavor. This is particularly true in ready-to-eat snacks. However, there are many challenges in making such snacks, including maintaining the desired structure and shape of the filling or topping without losing the taste, texture, or consistency of the filling or topping. It is also desirable that the filling or topping does not leak oil onto the rest of the food product upon cooking. On the manufacturing side, it is advantageous for the filling or topping to have a consistency that can be easily manipulated to produce a food product and for the filling or topping to have bake stability to prevent slumping or blow out of the filling or topping during cooking. Such qualities in the filling of topping can allow for snacks to be easily and safely cooked en masse. Thus, there is a need for filings and toppings that maintain a desired structure, have low oil leakage, and are bake stable, without comprising on texture and taste.

### SUMMARY OF THE DISCLOSURE

One aspect of the disclosure provides a stabilizer composition comprising:
a heat-settable material present in an amount in the range of 5-30 wt %;
starch present in an amount in the range of 25-70 wt %;
a plant protein present in an amount in the range of 0.2-50 wt %; and fiber comprising insoluble fiber, the fiber being present in an amount in the range of 3-30 wt %.

Another aspect of the disclosure provides a food composition suitable for use as a filling or topping, the food composition comprising:
one or more oleaginous components present in an amount in the range of 20-70 wt %;
one or more solid food components present in an amount in the range of 10-30 wt %; a heat-settable material present in an amount in the range of 1-18 wt %;
a starch present in an amount in the range of 6-42 wt %;
a plant protein present in an amount in the range of 0.1-25 wt %; and fiber comprising insoluble fiber, the fiber being present in an amount in the range of 1-18 wt %.

Another aspect of the disclosure provides a food composition suitable for use as a filling or topping, the food composition comprising:
one or more oleaginous components present in an amount in the range of 20-70 wt %;
one or more solid food components present in an amount in the range of 10-30 wt %; and
a stabilizer composition as described herein present in an amount in the range of 20-60 wt %.

Another aspect of the disclosure provides a method of making a food composition as described herein comprising providing one or more oleaginous components, and mixing with the one or more oleaginous components the one or more solid food components, the heat-settable material, the starch, the plant protein, and the fiber.

Another aspect of the disclosure provides a method of making a filled or topped food item comprising providing an uncooked food item comprising an uncooked dough and a filling or topping as described herein, and cooking the uncooked food item, thereby cooking the uncooked dough.

Another aspect of the disclosure provides a method of making a filled snack comprising sealing a food composition as described herein within an uncooked dough to provide an uncooked food item, and cooking the uncooked food item thereby cooking the uncooked dough.

In certain embodiments of the stabilizer composition, food compositions, and methods as described herein, the stabilizer composition and food composition include a heat-settable material, starch, a plant protein, and a fiber. When cooked, this blend of heat-settable material, starch, plant protein, and fiber, provides the desired structure and bake stability to fillings and toppings, without compromising on the texture of the filling or toppings. Accordingly, the compositions and methods described herein can advantageously create fillings or toppings that maintain a desired structure without losing the desired texture of the filling or topping. Furthermore, the consistency of the compositions prior to cooking is advantageous for producing filled snacks. For example, the consistency of the composition is advantageous for producing a filled snack with a coextrusion process as the consistency of the filling is pumpable with a dough.

### BRIEF DESCRIPTION OF THE DRAWINGS

FIG. 1 is a schematic view of a filled food item according to one embodiment of the disclosure; and

FIG. 2 is a schematic view of a topped food item according to another embodiment of the disclosure.

### DETAILED DESCRIPTION

To address various shortcomings of the prior art, the present inventors have developed a stabilizer composition that can be used to stabilize a variety of oil- or fat-containing fillings and toppings for cooked snacks. The stabilizer compositions can provide structure and support to the filling or topping, while maintaining acceptable texture, consistency and flavor thereof. The stabilizer composition an advantageously prevent oil or fat leaking from the filling and an undesirably high degree of slumping or blow out of the filing during baking. The stabilizer composition is easily incorporated into food compositions of a variety of flavors and can be used to produce ready-to-eat food products by a variety of methods. In view of the present disclosure, the stabilizer compositions, food compositions, and methods described herein can be configured by the person of ordinary skill in the art to meet the desired need. In general, the disclosed compositions and methods provide improvements of fillings and toppings that include at least a heat-settable material, a starch, a plant protein, and fiber.

One embodiment of the disclosure is a stabilizer composition comprising:
a heat-settable material present in an amount in the range of 5-30 wt %;
starch present in an amount in the range of 25-70 wt %;
a plant protein present in an amount in the range of 0.2-50 wt %; and fiber including insoluble fiber, the fiber being present in an amount in the range of 3-30 wt %.
   In various particular embodiments of the disclosure, the stabilizer composition is in the form of a dry solid, e.g., particulate form. The stabilizer composition can, for example, be provided in powdered or granular form. Such dry forms allow for convenient storage, handling, and admixture into food compositions.

As used herein, a heat-settable material is a material that will gel when heated. As such, the heat-settable material is not particularly limited and any edible heat-settable material known to gel when heated, as will be known to those skilled in the art, is acceptable for use in the stabilizer composition. For example, the heat-settable material may form a thermally-reversible gel. In other embodiments, the heat-settable material can form a nonreversible gel. Without intending to be bound by theory, it is believed that the heat-settable material acts as a binder, to help bind the various components together.

In some cases, some low degree of moisture may be necessary for gelation: however, the inherent moisture of the materials of the stabilizer composition or of a food composition itself may provide be sufficient moisture for gelation in use. In various particular embodiments as otherwise described herein, the heat-settable material has an inherent moisture content in the range of 1-20 wt %, e.g., 3-20 wt %, or 1-10 wt %, or 53-10 wt. %, as measured at equilibrium at 50% relative humidity and 20° C. Of course, in other embodiments, the materials of the stabilizer composition can be drier than this, and any necessary moisture can be provided by other materials in an overall item to be cooked. For example, in various embodiments as disclosed herein the stabilizer composition is included with an oil or fat and a solid food component in a food composition, and the food composition is provided in a filled or topped food item together with a dough. In such cases, the dough can provide moisture to the food composition.

In various particular embodiments as otherwise described herein, the heat-settable material is a hydroxyalkylcellulose, an alkylcellulose, a carboxycellulose, a heat-settable protein, or a combination thereof. The heat-settable material is not itself a plant protein; plant proteins are identified separately below.

For example, in some embodiments the heat-settable material is a hydroxyalkylcellulose, such a hydroxypropylmethylcellulose, hydroxypropylcellulose, hydroxyethylcellulose, or combinations thereof. In particular embodiments the heat-settable material is hydroxypropylmethylcellulose. In other embodiments, the heat-settable material is an alkylcellulose, such as a methylcellulose or an ethylcellulose. In other embodiments, the heat-settable material is a carboxycellulose, such as carboxymethylcellulose.

In other examples, the heat-settable material is a heat-settable protein, i.e., different than the plant protein otherwise provided in the composition. For example, in some embodiments, the heat-settable protein is an albumin, e.g. provided by egg white powder.

As noted above, the heat-settable material is present in the stabilizer composition in an amount in the range of 5-30 wt %. In various embodiments as otherwise described herein, the heat-settable material is present in an amount in the range of 5-25 wt %, e.g., 5-20 wt %, or 5-15 wt %, or 5-10 wt %. In various embodiments as otherwise described herein, the heat-settable material is present in an amount in the range of 10-30 wt %, e.g., 10-25 wt %, or 10-20 wt %, or 10-15 wt %. In various embodiments as otherwise described herein, the heat-settable material is present in an amount in the range of 15-30 wt %, e.g., 15-25 wt % or 15-20 wt %, or 20-30 wt %. Based on the disclosure herein, the person of ordinary skill in the art will select an appropriate amount of heat-settable material in combination with other components to provide a desired balance of oil retention, rheological properties and post-cooking texture in a food composition including the stabilizer composition.

The starch component of the stabilizer composition is not particularly limited and many starches known to those skilled in the art will be acceptable for use therein. Without being bound by theory, the starch is not believed to interact strongly with other filling components themselves, rather acting as a filler and oil absorber. However, when used in a food item or filled snack comprising a cooked dough the starch does appear to mediate the interaction between the filling and the cooked dough in contact with the filling, reducing the crustiness at the interface.

Types of starches may include, but are not limited to native (or unmodified) starch, modified starch, pre-gelatinized starch, pre-gelatinized-waxy starch, a cold-water swelling starch, an instant starch, a lipophilic starch, an unsubstituted starch, and a cook-up starch, among others. Further, starch may be produced from corn, waxy corn, potato, rice, wheat, or tapioca, among others. In certain embodiments, the starch may be a native starch. In other embodiments, the starch may be modified starch, which may be prepared by physically, enzymatically, or chemically treating native starch, resulting in a modified version of the starch. Modified starches are modified in a variety of fashions to improve food quality and performance. For example, modified starches may allow for less gelling, more stability, and greater water retention as compared to unmodified starches. Examples of modified starches include, but are not limited to: acid-treated starch, roasted starch with hydrochloric acid (dextrin), alkaline-modified starch, bleached starch, oxidized starch, enzyme-treated starch, monostarch phosphate, distarch phosphate, acetylated starch, hydroxypropylated starch, hydroxyethyl starch, starch sodium octenyl succinate, starch aluminum octenyl succinate, cationic starch, and carboxymethylated starch, among others. Particular examples of types starches that may be present in the stabilizer composition include dent (i.e., corn) pregelatinized starches, dent granular starches, waxy (i.e., corn) pregelatinized starches, potato pregelatinized starches, waxy spray cook starches, tapioca pregelatinized starches, instant starches, lipophilic starches, fat mimetic starches, dent cookup starches, waxy cookup starches, tapioca cookup starches, potato cookup starches, and native (unmodified starches).

In particular embodiments of the present disclosure, the starch is granular. In particular embodiments of the present disclosure, the starch is pregelatinized. The present inventors have found that pregelatinized starches are especially desirable for use in the methods and compositions described herein. In particular embodiments of the present disclosure, the starch is an unmodified starch. In particular embodiments, the starch is a granular pre-gelatinized unmodified starch.

As described above, the starch is present in the stabilizer composition in an amount in the an amount in the range of 25-70 wt %. For example, in various embodiments as otherwise described herein, the starch is present in an amount in the range of 25-65 wt %, e.g., 25-60 wt %, or 25-55 wt %, or 25-50 wt %, or 25-45 wt %, or 25-40 wt %. In various embodiments as otherwise described herein, the starch is present in an amount in the range of 30-70 wt %, e.g., 30-65 wt %, or 30-60 wt %, or 30-55 wt %, or 30-50 wt %, or 30-45 wt %, or 30-40 wt %. In various embodiments as otherwise described herein, the starch is present in an amount in the range of 35-70 wt %, e.g., 35-65 wt %, or 35-60 wt %, or 35-55 wt %, or 35-50 wt %, or 35-45 wt %. In various embodiments as otherwise described herein, the starch is present in an amount in the range of 40-70 wt %, e.g., 40-65 wt %, or 40-60 wt %, or 40-55 wt %, or 40-50 wt %. In various embodiments as otherwise described herein, the starch is present in an amount in the range of 45-70 wt %, e.g., 45-65 wt %, or 45-60 wt %, or 45-55 wt %. In various embodiments as otherwise described herein, the starch is present in an amount in the range of 50-70 wt %, e.g., 50-65 wt %, or 50-60 wt %. Based on the disclosure herein, the person of ordinary skill in the art will select an appropriate amount of starch in combination with other components to provide a desired balance of oil retention, rheological properties and post-cooking texture in a food composition including the stabilizer composition.

Without intending to be bound by theory, it is believed that the plant protein of the stabilizer composition acts as an emulsifying agent to provide a desired texture to a food composition that includes the stabilizer composition, especially in the case of an oil- or fat-containing food composition. In various particular embodiments as otherwise described herein, the plant protein is a legume protein or a nut protein, or a combination thereof. For example, in some embodiments the plant protein is a legume protein, such as a bean protein, pea protein, chickpea protein, lentil protein, peanut protein, cashew protein, and pulse protein. For example, in some embodiments the plant protein is a nut protein, such as almond protein, pecan protein, walnut protein, hazelnut protein, or chestnut protein. In particular embodiments, the plant protein is a chickpea protein. Other particularly desirable plant proteins include soy protein, pea protein, and potato protein.

Also, a chemically or physically altered plant protein may be used, including, for example, a hydrolyzed protein, a micronized protein, or a microparticulate protein. In one embodiment, the protein may comprise a hydrolyzed protein. Hydrolyzed proteins may be made by treatment with aqueous acid or aqueous base, or by treatment with one or more enzymes. Other processes for producing hydrolyzed protein may alternatively be used. The hydrolyzed protein may be, for example, hydrolyzed soy protein, hydrolyzed vegetable protein, or hydrolyzed wheat protein. As would be recognized by the person of ordinary skill in the art, the use of hydrolyzed proteins aids in the modification of allergenic properties of the protein, thus allowing more suitable consumption by individuals suffering from food allergies,

As described above, the plant protein is present in an amount in the range of 0.1-50 wt %. The present inventors have determined that while relatively high amounts of plant protein (especially chickpea protein) provide excellent performance, plant protein-containing materials can be expensive, and a good balance of cost and performance can be achieved with lower amounts of plant protein. In various embodiments, the plant protein is present in the stabilizer composition in an amount in the range of 0.1-40 wt %, e.g., 0.1-30 wt %, or 0.1-20 wt %. In various embodiments, the plant protein is present in the stabilizer composition in an amount in the range of 0.1-15 wt %, e.g., 0.1-10 wt %, or 0.1-8 wt %. In various embodiments, the plant protein is present in the stabilizer composition in an amount in the range of 0.5-50 wt %, e.g., 0.5-40 wt %, or 0.5-30 wt %, or 0.5-20 wt %. In various embodiments, the plant protein is present in the stabilizer composition in an amount in the range of 0.5-15 wt %, e.g., 0.5-10 wt %, or 0.5-8 wt %. In various embodiments, the plant protein is present in the stabilizer composition in an amount in the range of 2-50 wt %, e.g., 2-40 wt %, or 2-30 wt %, or 2-20 wt %. In various embodiments, the plant protein is present in the stabilizer composition in an amount in the range of 2-15 wt %, e.g., 2-10 wt %, or 2-8 wt %. In various embodiments, the plant protein is present in the stabilizer composition in an amount in the range of 4-50 wt %, e.g., 4-40 wt %, or 4-30 wt %, or 4-20 wt %. In various embodiments, the plant protein is present in the stabilizer composition in an amount in the range of 4-15 wt %, e.g., 4-10 wt %, or 4-8 wt %. Based on the disclosure herein, the person of ordinary skill in the art will select an appropriate amount of plant protein (e.g., chickpea protein) in combination with other components to provide a desired balance of oil retention, rheological properties and post-cooking texture in a food composition including the stabilizer composition.

In various particular embodiments, the plant protein is provided in the form of a flour comprising the plant protein. For example, flours of any of the protein sources identified above can be used, such as chickpea flour.

The person of ordinary skill in the art will determine an appropriate amount of flour to provide the desired amount of plant protein, based, e.g., on the protein content of the flour. In various embodiments as otherwise described herein, the flour is present in the stabilizer composition in an amount in the range of 1-60 wt %, e.g., 1-50 wt %, 1-40 wt %, or 1-30 wt %, or 1-20 wt %. In various embodiments as otherwise described herein, the flour is present in the stabilizer composition in an amount in the range of 5-60 wt %, e.g., 5-50 wt %, or 5-40 wt %, or 5-30 wt %, or 5-20 wt %, In various embodiments as otherwise described herein, the flour is present in the stabilizer composition in an amount in the range of 10-60 wt %, e.g., 10-50 wt %, or 10-40 wt %, or 10-30 wt %, or 10-20 wt %. In various embodiments as otherwise described herein, the flour is present in the stabilizer composition in an amount in the range of 15-60 wt %, e.g., 15-50 wt %, or 15-40 wt %, or 15-30 wt %. In various embodiments as otherwise described herein, the flour is present in the stabilizer composition in an amount in the range of 20-60 wt %, e.g., 20-50 wt %, or 20-40 wt %, or 20-30 wt %. In various embodiments as otherwise described herein, the flour is present in the stabilizer composition in an amount in the range of 25-60 wt %, e.g., 25-50 wt %, or 25-40 wt %, or 25-35 wt %. In various embodiments as otherwise described herein, the flour is present in the stabilizer composition in an amount in the range of 30-60 wt %, e.g., 30-50 wt %, or 30-45 wt %, or 30-40 wt %. In various embodiments as otherwise described herein, the flour is present in the stabilizer composition in an amount in the range of 35-60 wt %, e.g., 35-50 wt %, or 35-45 wt %. In various embodiments as otherwise described herein, the flour is present in the stabilizer composition in an amount in the range of 40-60 wt %, e.g., 40-55 wt %, or 40-50 wt %. Based on the disclosure herein, the person of ordinary skill in the art will select an appropriate amount of plant flour (e.g., chickpea flour) in combination with other components to provide a desired balance of oil retention, rheological properties and post-cooking texture in a food composition including the stabilizer composition.

Without intending to be bound by theory, it is believed that the fiber of the stabilizer composition provides a sort of scaffold for the maintenance of a filling or topping structure through cooking. As used herein, “fiber” refers to fiber that is added in isolated, purified or processed form.

As noted above, the fiber comprises an insoluble fiber, i.e., a fiber that is not soluble in water. As used herein, “soluble” fiber is a fiber fraction that will dissolve in water at a concentration of 1 g fiber in 20 g of water. Soluble and insoluble fractions of a particular fiber source can be determined gravimetrically by taking up 1 g fiber in 20 g water at room temperature, dissolving, and filtering and weighing the insoluble residue as insoluble fiber. In particular embodiments, the fiber comprises both insoluble fiber and soluble fiber. For example, in some embodiments at least 30% of the fiber is insoluble fiber, e.g., at least 40% of the fiber is insoluble fiber.

As noted above, the fiber is present in the stabilizer composition in an amount in the range of 3-30 wt %. For example, in various embodiments, the fiber is present in the stabilizer composition in an amount in the range of 3-25 wt %, e.g., 3-20 wt %, or 3-15 wt %, or 3-10 wt %. In various embodiments, the fiber is present in the stabilizer composition in an amount in the range of 5-30 wt %, e.g., 5-25 wt %, or 5-20 wt %, or 5-15 wt %, or 5-10 wt %. In various embodiments, the fiber is present in the stabilizer composition in an amount in the range of 10-30 wt %, e.g., 10-25 wt %, or 10-20 wt %, or 10-15 wt %. In various embodiments, the fiber is present in the stabilizer composition in an amount in the range of 15-30 wt %, e.g., 15-25 wt %, or 15-20 wt %. Based on the disclosure herein, the person of ordinary skill in the art will select an appropriate amount of fiber (e.g., citrus fiber) in combination with other components to provide a desired balance of oil retention, rheological properties and post-cooking texture in a food composition including the stabilizer composition.

The fiber may be fiber derived from plants, including fruits, vegetables, legumes, grains, and nuts, among others. In certain embodiments, the fiber may be derived from one or more of the following plants: acai, aloe, apple, apricot, banana, blackberry, blueberry, boysenberry, cantaloupe, cherry, coffee, coconut, corn, cranberry, date, elderberry, fig, gooseberry, grape, grapefruit, citrus, guava, honeydew, kiwi, konjac, kumquat, lemon, lime, mango, nectarine, orange, papaya, passion fruit, peach, pear, persimmon, pineapple, plantain, plum, pomegranate, prune, pumpkin, raspberry, star fruit, strawberry, tangerine, tomato, watermelon, avocado, cabbage, carrot, celery, cucumber, elderflower, kale, leek, potato, spinach, zucchini, oats, barley, rye, chia, soy, psyllium seed husks, almonds, pistachios, peanuts, macadamia nuts, walnuts, pecans, and sunflower seeds. The person of ordinary skill in the art will appreciate that other types of fruit, vegetables, plants, legumes, grains, and nuts may be alternatively or additionally used. The fiber may be from a combination of various fruits, vegetables, plants, legumes, grains, and nuts; the person ordinary skill will appreciate that different blends of fruit and vegetables can provide different flavors and consistencies to the stabilizer composition. The fiber may be, for example, a corn fiber, for example a processed corn fiber. In yet further embodiments, the fiber is an oat fiber, such as oat beta-glucan. In other embodiments, the fiber is a citrus fiber. Mixtures of fibers from different sources can be used.

While other components can be present in the stabilizer compositions described herein, it is desirable that the stabilizer composition be primarily made up of the components described above. For example, in some embodiments of the present disclosure, the total amount of the heat-settable material, the starch, the plant protein and the fiber is at least 60 wt % of the stabilizer composition, e.g., at least 65 wt % or at least 70 wt %.

In some embodiments of the present disclosure, where the plant protein is provided in the form of a flour, the total amount of the heat-settable material, the starch, the plant flour and the fiber is at least 80 wt %, of the stabilizer composition, e.g., at least 90 wt % or at least 95 wt %.

In particular embodiments of the present disclosure, the stabilizer composition includes a heat-settable compound that is a hydroxyalkylcellulose, a plant protein that is chickpea protein, and a fiber that is citrus fiber. For example, is some embodiments the stabilizer composition includes a heat-settable compound that is hydroxypropylmethylcellulose, a plant protein that is chickpea protein, and a fiber that is citrus fiber. In other embodiments, the stabilizer composition includes a heat-settable protein that is hydroxypropylmethylcellulose, a plant protein that is a chickpea protein provided in the form of chickpea flour, and a fiber that is citrus fiber. In certain such embodiments, the stabilizer composition includes 5-25 wt % hydroxyalkylcellulose (e.g., hydroxypropylmethylcellulose); 25-45 wt % starch; 2-15 wt % chickpea protein; and 5-25 wt % citrus fiber. In certain such embodiments, the stabilizer composition includes 10-20 wt % hydroxyalkylcellulose (e.g., hydroxypropylmethylcellulose); 30-40 wt % starch; 4-10 wt % chickpea protein; and 10-20 wt % citrus fiber. In certain such embodiments, the stabilizer composition includes 5-25 wt % hydroxyalkylcellulose (e.g., hydroxypropylmethylcellulose); 25-45 wt % starch; 25-45 wt % chickpea flour; and 5-25 wt % citrus fiber. In certain such embodiments, the stabilizer composition includes 10-20 wt % hydroxyalkylcellulose (e.g., hydroxypropylmethylcellulose); 30-40 wt % starch; 30-40 wt % chickpea flour; and 10-20 wt % citrus fiber,

Another aspect of the present disclosure relates to food compositions suitable for use as fillings or toppings. In particular embodiments of the disclosure, the food composition includes one or more oleaginous components present in an amount in the range of 20-70 wt %, one or more solid food components present in an amount in the range of 10-30 wt %, a heat-settable material present in an amount in the range of 1-18 wt %, a starch present in an amount in the range of 6-42 wt %, a plant protein present in an amount in the range of 0.1-25 wt %, and a fiber present in an amount in the range of 1-18 wt %. The heat-settable material, starch, plant protein, and fiber suitable for use in the food composition are described herein. In particular embodiments, the food composition has a water content of no more than 15 wt %, e.g., no more than 10 wt %, or even no more than 5 wt %. However, some moisture can be provided, e.g., as inherent parts of various components, and can be helpful in setting of the heat-settable material.

As used herein, an oleaginous component is an oil or a fat, which can be provided separately or as part of another ingredient. In some embodiments, the one or more oleaginous components is present in an amount in the range of 20-70 wt %, e.g., 20-60 wt %, or 20-50 wt %, or 20-40 wt %, or 20-30 wt %, or 30-70 wt %, or 30-60 wt %, or 30-50 wt %, or 30-40 wt %, or 40-70 wt %, or 40-60 wt %, or 40-50 wt %, or 50-70 wt %, or 50-60 wt %. In particular embodiments, the one or more oleaginous components is a liquid at room temperature. In particular embodiments, the one or more oleaginous components is a solid at room temperature. For example, in some embodiments, the one or more oleaginous components comprise palm oil, canola oil, soybean oil, grapeseed oil, vegetable oil, sunflower oil, coconut oil, olive oil, avocado oil, peanut oil, or combination thereof. In particular examples, the one or more oleaginous components comprise palm oil, canola oil, soybean oil, or combinations thereof. In other embodiments, the one or more oleaginous components comprise a lecithin such as sunflower lecithin, canola soy lecithin, or egg lecithin. In particular examples, the lecithin is a sunflower lecithin, a canola lecithin or a soy lecithin.

In some embodiments the one or more solid food components are present in an amount in the range of 10-45 wt %, e.g., 10-35 wt %, or 10-25 wt %, or 10-20 wt %, or 15-45 wt %, or 15-35 wt %, or 15-25 wt % or 20-45 wt %, or 20-35 wt %, or 25-45 wt %. In particular embodiments, the one or more solid food components are selected from the group comprising a cheese powder, a fruit or vegetable material, or a chocolate powder. In particular embodiments of the present disclosure, the one or more solid food components is a cheese powder. The flavor of the cheese powder is not particularly limited and can be selected from any cheese powder as known to those skilled in the art. For example, the cheese powder may have a flavor such as mild cheddar, sharp cheddar, white cheddar, parmesan, asiago, provolone, blue cheese, Swiss cheese, mozzarella cheese, cream cheese, or combinations thereof. The fruit or vegetable material is not particularly limited and can be selected from any fruit or vegetable material as known to those skilled in the art. For example, the fruit or vegetable material may be selected from: acai, aloe, apple, apricot, banana, blackberry, blueberry, boysenberry, cantaloupe, cherry, coconut, cranberry, date, elderberry, fig, gooseberry, grape, grapefruit, guava, honeydew, kiwi, kumquat, lemon, lime, mango, nectarine, orange, papaya, passion fruit, peach, pear, persimmon, pineapple, plantain, plum, pomegranate, prune, pumpkin, raspberry, star fruit, strawberry, tangerine, tomato, watermelon, avocado, cabbage, carrot, celery, cucumber, elderflower, kale, leek, potato, spinach, and zucchini. Other types of fruit and vegetables may be available as well. The chocolate powder is not particularly limited and can be selected from any chocolate powder known to those skilled in the art. For example, the chocolate powder may be selected from dark chocolate, milk chocolate, white chocolate, or ruby chocolate. In some embodiments, the chocolate powder may also contains a non-chocolate flavor, such as orange, raspberry, coconut, almond, hazelnut, peanut butter, walnut, pecan, caramel, marshmallow, mint, or combinations thereof. And the person of ordinary skill in the art will appreciate that a variety of other solid food components can be used, to provide a desired flavor to the food composition.

In particular embodiments of the food composition, the heat-settable material is a heat-settable material as described herein with respect to the stabilizer composition. In particular embodiments of the food composition, the heat-settable material is present in an amount in the range of 1-18 wt %, e.g., 1-15 wt %, or 1-10 wt %, or 1-5 wt %, or 5-18 wt %, or 5-15 wt %, or 5-10 wt %, or 10-18 wt %, or 10-15 wt %.

In particular embodiments of the food composition, the starch is a starch as described herein with respect to the stabilizer composition. In particular embodiments of the food composition, the starch is present in an amount in the range of 6-42 wt %, e.g., 6-35 wt %, or 6-25 wt %, or 6-18 wt %, or 15-42 wt %, or 15-35 wt %, or 15-25 wt %, or 25-42 wt %, or 25-35 wt %.

In particular embodiments of the food composition, the plant protein is a plant protein as described herein. In particular embodiments of the food composition, the plant protein as described herein is present in an amount in the range of 0.1-25 wt %, e.g., 0.1-15 wt %, or 0.1-10 wt %, or 0.1-5 wt %, or 0.5-25 wt %, or 0.5-15 wt %, or 0.5-10 wt %, or 0.5-5 wt %, or 2-25 wt %, or 2-15 wt %, or 2-10 wt %, or 2-5 wt %. In particular embodiments of the food composition, the plant protein is provided as a plant flour as described herein and the plant flour is present in an amount in the range of 0.5-50 wt %, e.g., 0.5-35 wt %, or 0.5-20 wt %, or 2-50 wt %, or 2-35 wt %, or 2-20 wt %, or 10-50 wt %, or 10-35 wt %, or 10-20 wt %.

In particular embodiments of the food composition, the fiber is a fiber as described herein. In particular embodiments of the food composition, the fiber as described herein is present in an amount in the range of 1-18 wt %, e.g., 1-12 wt %, or 1-8 wt %, or 1-4 wt %, or 4-18 wt %, or 4-12 wt %, or 4-8 wt %, or 6-18 wt %, or 6-12 wt %.

A particular advantage of the advances described herein is that various food compositions of the disclosure can maintain their structure while cooking (e.g., by baking or frying), while still providing acceptable taste, texture, and consistency of the composition. For example, in particular embodiments, a 2 g body of the food composition formed in a roughly spherical body does not slump to a height of less than 4 mm upon baking the composition at 350° F. for 10 minutes then 250° F. for 20 minutes. Especially desirable materials maintain at least 4 mm height, but do flow somewhat during heating, which indicates that the material can be pumpable.

In some embodiments, the food composition has a Bostwick consistency (30 seconds, 23° C.) of 2 to 7 cm, e.g., 2 to 5 cm, or 2 to 4 cm, or 2 to 3 cm, or 3 to 7 cm, or 3 to 5 cm, or 3 to 4 cm, or 4 to 7 cm, or 4 to 5 cm. Bostwick viscosities are measured using a Bostwick viscometer on a level surface by filling the dam with a sample and scraping off excess, then opening the gate, allowing the sample to travel for 30 seconds, then recording the distance traveled.

In particular embodiments, the food composition include a heat-settable compound that is hydroxyalkylcellulose, a plant protein that is chickpea protein, and a fiber that is citrus fiber. For example, is some embodiments the food composition includes a heat-settable compound that is hydroxypropylmethylcellulose, a plant protein that is chickpea protein, and a fiber that is citrus fiber. In other embodiments, the food compositions includes a heat-settable compound that is hydroxypropylmethylcellulose, a plant protein is a chickpea protein provided in the form of chickpea flour, and a fiber that is citrus fiber. In certain such embodiments, the food composition includes 1-9 wt % hydroxyalkylcellulose (e.g., hydroxypropylmethylcellulose); 5-18 wt % starch; 1-5 wt % chickpea protein; and 1-9 wt % citrus fiber. In certain such embodiments, the food composition includes 1-9 wt % hydroxyalkylcellulose (e.g., hydroxypropylmethylcellulose); 5-18 wt % starch: 5-18 wt % chickpea flour; and 3-7 wt % citrus fiber. In certain such embodiments, the food composition includes 3-7 wt % hydroxyalkylcellulose (e.g., hydroxypropylmethylcellulose); 7-16 wt % starch; 1.5-4 wt % chickpea protein; and 3-7 wt % citrus fiber. In certain such embodiments, the food composition includes 3-7 wt % hydroxyalkylcellulose (e.g., hydroxypropylmethylcellulose); 7-16 wt % starch; 7-16 wt % chickpea flour; and 3-7 wt % citrus fiber.

As the person of ordinary skill in the art will appreciate, a wide variety of additional components may be present in the food composition, for example, to enhance flavor, viscosity, consistency, structure or processability. Examples of such additional components may include, but are not limited to, fruit or vegetable solids, sweetening agents, acids, or flavoring ingredients.

The heat-settable material, the starch, the plant protein and the fiber can be provided to a food composition in the form of a stabilizer composition as described herein. Thus, another aspect of the disclosure provides a food composition suitable for use as a filling or topping, the food composition comprising:
one or more oleaginous components present in an amount in the range of 20-70 wt %;
one or more solid food components present in an amount in the range of 10-30 wt %; and
a stabilizer composition as described herein present in an amount in the range of 20-60 wt %.

The oleaginous component(s) and solid food component(s) can be of identities and in amounts as described above with respect to the food compositions previously described. And the heat-settable material, the starch, the plant protein and the fiber can be of identities and in amounts as described above with respect to the stabilizer compositions previously described. The stabilizer composition can be present in a variety of amounts, e.g., 20-55 wt %, or 20-50 wt %, or 20-45 wt %, or 20-40 wt %, or 20-35 wt %, or 25-60 wt %, or 25-55 wt %, or 25-50 wt %, or 25-45 wt %, or 25-40 wt %, or 25-35 wt %, or 30-60 wt %, or 30-55 wt %, or 30-50 wt %, or 30-45 wt %, or 30-40 wt %, or 35-60 wt %, or 35-55 wt %, or 35-50 wt %, or 35-45 wt %, or 40-60 wt %, or 40-55 wt %, or 40-50 wt %.

Another aspect of the present disclosure provides a method of making a food composition as described herein by providing the one or more oleaginous components and mixing with the one or more oleaginous components the one or more solid food components, the heat-settable material, the starch, the plant protein, and the fiber. In some embodiments the one or more solid food components, the heat-settable material, the starch, the plant protein, and the fiber are dry powders or granular solids. In particular embodiments, the one or more solid food components, the heat-settable material, the starch, the plant protein, and the fiber are mixed together to form a dry mix prior to mixing with the one or more oleaginous components. As will be appreciated by those skilled in the art, premixing the dry ingredients provides a more even distribution of the dry mix when added to the one or more oleaginous components. In particular embodiments, the dry mix is gradually added to the one or more oleaginous components. For example, in some embodiments, the dry mix may be gradually added to the one or more oleaginous components while mixing until a thick paste is formed. In some embodiments, the dry mix may be gradually added to the one or more oleaginous components until all of the oleaginous component is incorporated with the dry mix. In particular examples, the heat-settable material, the starch, the plant protein, and the fiber are provided as a stabilizer composition as described herein.

The food composition as described herein is particularly suitable as a filling in a food item or a topping on a food item. Another aspect of the present disclosure provides a method of making a filled or topped food item by providing an uncooked food item comprising an uncooked dough, providing a filling or topping comprising the food composition as described herein adjacent to the uncooked dough, and cooking the uncooked food item, thereby cooking the uncooked dough.

Another aspect of the present disclosure provides a method of making a filled snack comprising sealing a food composition as described herein within an uncooked dough to provide an uncooked food item, and cooking the uncooked food item. thereby cooking the uncooked dough. Sealing the food composition within the uncooked dough can be accomplished by any means known to those skilled in the art. For example, sealing the food composition can include crimping, folding, cutting, or a combination thereof. For example, in specific embodiments of the present disclosure, sealing the food composition within the uncooked dough includes coextruding the food composition within a tube of the uncooked dough to form an extrudate and cutting the extrudate into uncooked food items, the cutting sealing the ends of each uncooked food item.

In embodiments of the present disclosure, the food composition is heated prior to sealing the food composition within the uncooked dough or disposing the food composition adjacent the uncooked dough. For example, the food composition may be heated to a temperature in the range of 150-180° F., e.g., 150-170° F., or 150-160° F., or 155-180° F., or 155-170° F. or 155-160° F., or 160-180° F. or 160-170° F. or 165-180° F. or 165-170° F.

Cooking can be accomplished by any means known to the person of ordinary skill in the art and includes, but is not limited to, deep frying, shallow frying, air frying, boiling, and baking. In particular embodiments of the present disclosure, the food composition as described herein is stable upon cooking the uncooked food item. In particular embodiments of the present disclosure, cooking occurs at a temperature and for a time that is sufficient to cook the uncooked dough. For example, cooking occurs at a temperature of at least 325° F., e.g., at least 350° F., or at least 375° F. In other embodiments, cooking occurs at a temperature in the range of 325-400° F., e.g., 350-400° F., or 325-375° F., or 325-350° F., or 350-375° F. In particular embodiments, cooking occurs for a time of at least 5 minutes, e.g., at least 8 minute or at least 10 minutes. In other embodiments, cooking occurs for a time in the range of 5 to 20 minutes, e.g., 5 to 18 minutes, or 5 to 15 minutes, or 5 to 12 minutes, or 8 to 20 minutes, or 8 to 18 minutes, or 8 to 15 minutes, or 8 to 12 minutes, or 10 to 20 minutes, or 10 to 18 minutes, or 10 to 12 minutes.

In particular embodiments, cooking occurs at a first temperature for a first amount of time and a second temperature for a second amount of time. For example, in some embodiments, the first temperature is in the range of 325-400° F., e.g., 350-400° F., or 375-400° F., or 325-375° F., or 325-350° F., or 350-375° F. In some embodiments, the first time is in the range of 5 to 20 minutes, e.g., 5 to 18 minutes, or 5 to 15 minutes, or 5 to 12 minutes, or 8 to 20 minutes, or 8 to 18 minutes, or 8 to 15 minutes, or 8 to 12 minutes, or 10 to 20 minutes, or 10 to 18 minutes, or 10 to 12 minutes. In some embodiments, the second temperature is in the range of 200-300° F., e.g., 200-275° F., or 200-250° F., or 225-300° F., or 225-275° F., or 225-250° F., or 250-300° F., or 275-300° F. In some embodiments, the second time is in the range of 15 to 30 minutes, e.g., 15 to 25 minutes, or 15 to 20 minutes, or 20 to 30 minutes, or 20 to 25 minutes, or 25 to 30 minutes. In particular embodiments, the first temperature is higher than the second temperature, and the first time is shorter than the second time. For example, in particular embodiments, the first temperature is in the range of 325-400° F., e.g., 350-400° F., or 375-400° F., or 325-375° F., or 325-350° F., or 350-375° F., and the second temperature is in the range of 200-300° F., e.g., 200-275° F., or 200-250° F., or 225-300° F., or 225-275° F., or 225-250° F., or 250-300° F., or 275-300° F. For example, in particular embodiments, the first time is in the range of 5 to 15 minutes, or 5 to 12 minutes, or 8 to 15 minutes, or 8 to 12 minutes, or 10 to 12 minutes, and the second time is in the range of 15 to 30 minutes, or 15 to 25 minutes, or 15 to 20 minutes, or 20 to 30 minutes, or 20 to 25 minutes, or 25 to 30 minutes.

In particular embodiments, the uncooked dough and the food composition as described herein, are present in the food item or filled snack in a ratio in the range of 1:5 to 5:1, e.g., 1:3 to 5:1, or 1:2 to 5:1, or 1:1 to 5:1, or 1:5 to 3:1, or 1:3 to 3:1, or 1:2 to 3:1, or 1:1 to 3:1, or 1:5 to 2:1, or 1:3 to 2:1, or 1:2 to 2:1, or 1:1 to 2:1, or 1:5 to 1:1, or 1:3 to 1:1, or 1:2 to 1:1.

The type of uncooked dough is not particularly limited and may be any dough known to the person of ordinary skill in the art. For example, in some embodiments, the uncooked dough is a pastry dough, or a cookie dough, or a cracker dough, or a pretzel dough. In particular embodiments, the uncooked dough is a pretzel dough. In other embodiments, the uncooked dough is a combination of uncooked doughs, such as pastry doughs, cookie doughs, cracker doughs, or pretzel doughs.

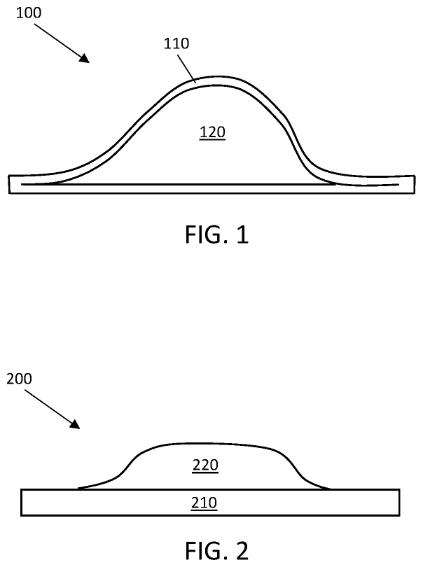

A wide variety of food items can be provided. For example, one embodiment of a food item is a filled food item. An example is shown in the schematic cross-sectional view of FIG. 1. In food item 100, a cooked dough 110 surrounds a filling 120. Such filled food items can be provided in many forms, e.g., as filled pretzel snack pieces, as filled dumplings, as filled buns, as filled pastas such as ravioli and tortellini, and as pastries such as turnovers and toaster pastries, among myriad others. These can be made by a variety of the methods as described above, e.g., by co-extruding the dough and a food composition as described herein, then pinching closed the dough to seal filling inside and cooking the resulting uncooked piece. But other methods can be used, for example, conventional operations used to make filled dumplings, buns, pastas and pastries. An example of a topped food item is shown in the cross-sectional schematic view of FIG. 2. Here, topped food item 200 includes a cooked dough 210 on which a topping 220 is disposed. Such food items can be provided in many forms, e.g., as cookies, as pastries such as danishes and sweet rolls, among myriad others. In all cases, the food compositions described herein, e.g., made using a stabilizer composition as described herein, can be used to provide the fillings or toppings.

### Examples

The Examples that follow are illustrative of specific embodiments of the process of the disclosure, and various uses thereof. They are set forth for explanatory purposes only, and are not to be taken as limiting the scope of the disclosure.

To begin, the present inventors evaluated food compositions with and without different components to design a composition with a pumpable consistency before baking that maintained a creamy, smooth texture and a desirable degree of shape stability after baking. Compositions were prepared and generally subjected to two tests: In a first test, a 2 g body of the food composition was formed in a roughly spherical body on a piece of filter paper, and the composition is baked at 350° F. for 10 minutes then 250° F. for 20 minutes. The height of the composition and the diameter of the oil stain on the filter paper was measured after, baking. In a second test, the food composition was wrapped in a commercial wonton wrapper and baked under the same conditions described above.

Table 1 shows the results with respect to oil leakage and slump of compositions with dry blend consisting only of a cheese powder and a starch. Amounts of materials are provided as parts by weight.

TABLE 1

| Trial | Control | 1 | 2 | 3 | 4 |
|---|---|---|---|---|---|
| Canola oil | — | 47 | 47 | 47 | 47 |
| Soy lecithin | — | 0 | 0.6 | 0 | 0 |
| Cheese powder 1 | — | 20 | 20 | 0 | 0 |
| Cheese powder 2 | — | 0 | 0 | 20 | 20 |
| Instant-gelling | — | 28 | 28 | 28 | 28 |
| starch | | | | | |
| Instant film- | — | 5 | 5 | 5 | 0 |
| forming starch | | | | | |
| Diameter of oil | 1 | 1.31 | 1.43 | 1.33 | 1.36 |
| ring* | | | | | |
| Height of mound** | M | H | M | M | M |

*as a ratio to the control.
**H = holds shape without evidence of significant pumpability; M = height above 4 mm but pumpable; L = flattens to less than 4 mm in height.

As will be known by those skilled in the art, natural peanut butter (i.e. made with solely peanuts and salt) is itself a relatively bake-stable composition. As such, natural peanut butter was used as the control, which had an oil ring diameter of 8.1 cm. All of the compositions tested in trials 1-4 had larger oil rings than the control, indicating that they tended to leak more oil upon baking.

The wonton-wrapped samples were evaluated. Trial 1 had a chewy and hard texture, and oil was observed between the cooked dough and the filling. Trial 2 was found to be greasier than trial 1, as well as having a gritty texture that broke down quickly. Trial 3 was found to have a good consistency that was not too greasy, but a texture that was very chewy and hard. Trial 4 was found to contain some wet oil in the center of the filling after baking. Accordingly the present inventors have found that a dry blend that only include a cheese powder and a starch, in combination with an oleaginous component, did not provide desirable filling compositions as the oil is not maintained in the composition during baking, and the textures tended to be gritty and chewy.

Compositions including both a heat-settable material and a fiber in addition to the starch were tested, as described above. The compositions and results are detailed in Table 2. As before, the control was natural peanut butter.

TABLE 2

| Trial | Control | 5 | 6 | 7 | 8 |
|---|---|---|---|---|---|
| Canola oil | — | 47 | 47 | 47 | 47 |
| Soy lecithin | — | 0 | 0 | 0.6 | 0.6 |
| Cheese powder 1 | — | 20 | 20 | 20 | 20 |
| HMPC | — | 5 | 0 | 5 | 0 |
| Instant-gelling | — | 23 | 23 | 23 | 23 |
| starch | | | | | |
| Instant film- | — | 0 | 5 | 0 | 5 |
| forming starch | | | | | |
| Citrus Fiber | — | 5 | 5 | 5 | 5 |
| Diameter of oil | 1 | 1.23 | 1.25 | 1.17 | 1.37 |
| ring* | | | | | |
| Height of mound** | M | H | H | M | M |

*as a ratio to the control.

*H=holds shape without evidence of significant pumpability: M=height above 4 mm but pumpable: L=flattens to less than 4 mm in height.

The present inventors found that the presence of both hydroxypropylmethylcellulose (HMPC) and citrus fiber markedly improved the retention of oil in the composition. The diameter of the oil ring of trials 5 and 7 were lower than all of the trials that only contained cheese powder and starch, and trials 6 and 7 that included cheese powder, starch and fiber without the HPMC.

However, the present inventors noted that the compositions could be further improved. While trial 5 cleared the mouth quickly, there was some grittiness to the filling. The texture of trial 6 was found to be slightly crusty, a result attributed to the presence of the film-forming starch. Trial 7 provided the best result of the four tested here, as the food composition had a creamier texture, cleared the mouth quickly, and tasted better than the other trials. Thus, the present inventors determined that a the presence of a heat-settable material and a fiber help to maintain oil in the composition better than when only cheese and starch are present, however the ultimate desired texture was still not achieved.

A plant protein, here, chickpea protein, was included in the compositions in trials 9-18. The compositions used as well as the diameter of the oil stain on the filter paper measured after baking are reported in Table 3. As before, natural peanut butter was used as the control.

TABLE 3

| Trial | Control | 9 | 10 | 11 | 12 | 13 | 14 | 15 | 16 | 17 | 18 |
|---|---|---|---|---|---|---|---|---|---|---|---|
| Palm oil-based | — | 40 | 46.8 | 42 | 42 | 42 | 37.8 | 40 | 40 | 40 | 40 |
| shortening | | | | | | | | | | | |
| Soy lecithin | — | 0.6 | 0.552 | 0.6 | 0.6 | 0.6 | 0.54 | 0.6 | 0.6 | 0.6 | 0.6 |
| Cheese powder 1 | — | 20 | 18.4 | 20 | 20 | 20 | 20 | 20 | 20 | 20 | 20 |
| HMPC | — | 16 | 14.72 | 16 | 16 | 16 | 14.4 | 16 | 16 | 11 | 13 |
| Instant-gelling | — | 0 | 0 | 0 | 0 | 0 | 0 | 0 | 0 | 10 | 4 |
| starch | | | | | | | | | | | |
| Citrus Fiber | — | 8 | 7.36 | 8 | 6 | 4 | 3.6 | 4 | 4 | 4 | 4 |
| Chickpea | — | 16 | 14.72 | 14 | 16 | 18 | 16.2 | 20 | 20 | 15 | 19 |
| protein | | | | | | | | | | | |
| Diameter of | 1 | 1.02 | 1.28 | 1.11 | 1.06 | 1.22 | nd** | nd | nd | 0.96 | nd |
| oil ring* | | | | | | | | | | | |

*as a ratio to the control.
**not determined

The addition of plant protein greatly improved the oil retention of the food composition. Indeed, all four claimed components were present, the diameter of the oil ring was smaller than that of the control.

With regards to the texture and consistency of the food compositions, trial 9 had an excellent texture after baking, however the prebake consistency was thicker than optimal. Trial 10 had more oil than trial 9, and this made the filling very runny and rather thin before baking. After baking, trial 10 had the largest oil ring, but after sitting the consistency of the filling did thicken. Trial 11 was similar to trial 9, with a thick prebake consistency. Trial 12 was runnier than trial 9, but was still relatively thick and had a burnt taste after baking. Trial 13 had a very good consistency both before and after baking, but left a larger oil ring than trial 9. Trial 14 was similar to trial 13, except sugar was added to evaluate the impact on taste. The present inventors determined that there was no need to include sugar in the cheese filling to improve taste. Trial 15 had a better prebake consistency than trial 9. Trial 16 burnt very easily when baked.

Trial 17 was found to be better than both trial 9 and trial 15 as it had an excellent shape-stable yet flowable consistency both pre- and post-bake. Trial 17 also had a more clean feeling on the tongue and less mouth coating, with more flavor apparent. Trial 18 was similar to trial 15, although not as good as trial 17. Based on these trials, the present inventors identified that the combination of a plant protein and starch was important in that it provides the desired consistency both before and after baking.

Having identified that a heat-settable material, starch, plant protein, and fiber provided promising food compositions, the effect of the oil was evaluated. Table 4 shows the compositions tested, as well as the height of the mount and diameter of the oil ring measured. As before, natural peanut butter was used as the control, but it is not shown in Table 4.

TABLE 4

| Trial | 17 | 18 | 19 | 20 | 21 | 22 | 23 | 24 | 25 | 26 | 27 |
|---|---|---|---|---|---|---|---|---|---|---|---|
| Palm oil-based | 40 | 40 | 40 | | | | | | | | |
| shortening | | | | | | | | | | | |
| Canola oil | | | | 40 | 40 | 46.8 | 40.8 | 45.1 | 47 | 47 | 49.24 |
| Soy lecithin | 0.6 | 0.6 | | | 0.6 | | 0.6 | | | | |
| Cheese powder 1 | 20 | 20 | 20 | 20 | 20 | 18.4 | 18.4 | 17 | 17.7 | 20 | 18.4 |
| HMPC | 11 | 13 | 11 | 11 | 11 | 10.12 | 10.1 | 9.3 | 9.7 | 5 | 4.6 |
| Instant-gelling | 10 | 4 | 10 | 10 | 10 | 9.2 | 9.2 | 8.5 | 8.8 | 18 | 16.56 |
| starch | | | | | | | | | | | |
| Citrus Fiber | 4 | 4 | 4 | 4 | 4 | 3.68 | 3.7 | 3.4 | 3.5 | 5 | 4.6 |
| Chickpea | 15 | 19 | 15 | 15 | 15 | 13.8 | 13.8 | 12.7 | 13.2 | 5 | 4.6 |
| protein | | | | | | | | | | | |
| Diameter of | 0.96 | nd | 1.04 | 0.99 | 1.16 | 1.20 | 1.21 | 1.17 | nd | 1.23 | 1.28 |
| oil ring* | | | | | | | | | | | |
| Height of | H | nd | H | H | H | H | H | M | nd | H | H |
| mound** | | | | | | | | | | | |

*as a ratio to the control.
**H = holds shape without evidence of significant pumpability; M = height above 4 mm but pumpable; L = flattens to less than 4 mm in height.

Trials 17 and 18 are the same trials listed Table 3, but are shown in Table 4 for comparison between the palm oil-based shortening and canola oil. Trials 19-24 all have relatively small oil ring diameters. Trial 19 was much thicker and dryer in consistency than trial 17, indicating that the presence of lecithin plays a role in the consistency of the filling before baking. The oil ring is also slightly larger than that of trial 17. After baking, trial 19 was slightly dryer than trial 17 and did not have a desirable consistency. Trial 20 is also very thick and dry, similar to trial 19. The difference between trial 17 and trial 21 was minimal, indicating that either oil is suitable. Trial 22 includes more oil than the previous trial tested. Trials 23, 24, and 25 are similar to trial 17, but with just slightly more oil, which thinned down the consistency of the composition before baking significantly. Trials 26 and 27 decrease the amount of chickpea protein and citrus fiber, as well as use hydroxypropylmethylcellulose in a lower amount. However, both composition were thick prebake, and had larger but still acceptable oil ring diameters. Overall, the present inventors found that the addition of lecithin can provide desirable consistency, but is not necessary to make the food composition flowable. They also found that the type of oil is not particularly significant in producing a desired food composition.

To further understand the role of plant protein in the food compositions, the inclusion of other sources of protein were investigated, including cake flour, regular flour, and chickpea flour. Trials 28-33 evaluate the effect of different types of flour and different starches on the compositions. The specific compositions tested, as well as the diameter of the oil ring and the height of the mound measured after baking, are described in Table 5.

TABLE 5

| Trial | 28 | 29 | 30 | 31 | 32 | 33 |
|---|---|---|---|---|---|---|
| Canola oil | 47 | 47 | 47 | 47 | 47 | 47 |
| Canola lecithin | 0.3 | 0.3 | 0.3 | 0.3 | 0.3 | 0.3 |
| Cheese powder | 20 | 20 | 20 | 20 | 20 | 20 |
| HMPC | 5 | 5 | 5 | 5 | 5 | 5 |
| Instant-gelling starch | 23 | 11.5 | 11.5 | 11.5 | 11.5 | 11.5 |
| Cornstarch | | | | 11.5 | | |
| Citrus Fiber | 5 | 5 | 5 | 5 | 5 | 5 |
| Chickpea Flour | | | | | | 11.5 |
| Chickpea Protein | | 11.5 | | | | |
| All-purpose wheat flour | | | | | 11.5 | |
| Cake flour | | | 11.5 | | | |
| Diameter of oil ring* | 1.4 | 1.4 | 1.4 | 1.4 | 1.3 | 1.3 |
| Height of mound** | M | L | M | L | M | L |

*as a ratio to the control.
**H = holds shape without evidence of significant pumpability; M = height above 4 mm but pumpable; L = flattens to less than 4 mm in height.

Trial 28 does not include any chickpea protein or source of flour and serves as a control for these trials. Before baking, trial 28 was relatively thick, but was still flowable. However, after baking the composition was a hard and a little bit crusty. Trial 29 included chickpea protein and had a thin and flowable consistency. After baking, trial 29 was darker in color, but maintained a creamy texture. However, some loss of flavor was observed. Trial 30 had a thick, pasty, and chunky consistency before baking. After baking, trial 30 was less crusty than trial 28, but had a grainy texture. Trial 31 did not include and chickpea protein or flour, but included a 50/50 blend of standard cornstarch and instant-gelling starch. The consistency of the trial 31 was thin and flowable. After baking, it had some crustiness and grittiness, but a clean flavor. Trial 32 used regular flour and produced a thick, pasty, and chunky consistency before baking. While trial 32 did have a clean flavor, it was grittier than trial 30, which contained cake flour. Trial 33 includes chickpea flour, as opposed to chickpea protein, and provided the best results for this trial. The consistency before baking was thin and flowable, similar to the consistency of icing. After baking, the texture of trial 33 was smooth and clean, and was better than trial 29 with just chickpea protein. While trial 33 did flatten some, it nonetheless held shape acceptably for many applications, and represents a good tradeoff of cost vs. performance. Thus, the present inventors found that by including a protein source a more creamy texture can be achieved after baking the food composition, with the best results including a chickpea protein source, be it chickpea protein per se or chickpea flour.

For further evaluation, a food composition as described here can be used to prepare a filled snack to evaluate their usefulness as a filling. To prepare the filled snack, a sheet of dough is prepared to a thickness of 1.0-1.10 mm with multiple passes through a Rondo reversible sheeter. The moisture content of the dough is 38-39%. The dough is cut into a desired length and width. The food compositions of Example 3 are then added to the dough in a dough to filling ratio of 60:40. The dough piece is folded over to enclose the food composition within the dough and all four sides of the filled dough piece is sealed. The filled dough piece is then placed on filter paper and baked at 375° F. for 4 to 5 minutes in a convection oven.

Other aspects of the disclosure are described with respect to the following claims, which may be combined in any fashion and in any number that is not technically or logically inconsistent.

Before the disclosed compositions, methods and products are described, it is to be understood that the aspects described herein are not limited to specific embodiments, apparatuses, or configurations, and as such can, of course, vary. It is also to be understood that the terminology used herein is for the purpose of describing particular aspects only and, unless specifically defined herein, is not intended to be limiting.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an” and “the” include plural referents unless the context clearly dictates otherwise.

Various exemplary embodiments of the disclosure include, but are not limited to: Embodiment 1 provides a stabilizer composition comprising:
a heat-settable material present in an amount in the range of 5-30 wt %:
starch present in an amount in the range of 25-70 wt %;
a plant protein present in an amount in the range of 0.2-50 wt %; and
fiber comprising insoluble fiber, the fiber being present in an amount in the range of 3-30 wt %.

Embodiment 2 provides the stabilizer composition of embodiment 1, in the form of a dry solid, e.g., in powdered or granular form.

Embodiment 3 provides the stabilizer composition of embodiment 1 or embodiment 2, wherein the heat-settable material has an inherent moisture content in the range of 1-20 wt %, e.g., 3-20 wt %, or 1-10 wt %, or 3-10 wt. %, as measured at equilibrium at 50% relative humidity and 20° C.

Embodiment 4 provides the stabilizer composition of any embodiments 1-3, wherein the heat-settable material is a hydroxyalkylcellulose, an alkylcellulose, a carboxycellulose, a heat-settable protein, or a combination thereof.

Embodiment 5 provides the stabilizer composition of any of embodiments 1-3, wherein the heat-settable material is a hydroxyalkylcellulose, such as hydroxypropylmethylcellulose or hydroxyethyl cellulose.

Embodiment 6 provides the stabilizer composition of any of embodiments 1-3, wherein the heat-settable material is hydroxypropylmethylcellulose.

Embodiment 7 provides the stabilizer composition of any of embodiments 1-3, wherein the heat-settable material is an alkylcellulose such as methylcellulose or ethylcellulose, or a carboxycellulose such as carboxymethylcellulose.

Embodiment 8 provides the stabilizer composition of any of embodiments 1-3, wherein the heat-settable material is a heat-settable protein, such as albumin.

Embodiment 9 provides the stabilizer composition of any of embodiments 1-8, wherein the heat-settable material is present in an amount in the range of 5-25 wt %, e.g., 5-20 wt %, or 5-15 wt %, or 5-10 wt %.

Embodiment 10 provides the stabilizer composition of any of embodiments 1-8, wherein the heat-settable material is present in an amount in the range of 10-30 wt %, e.g., 10-25 wt %, or 10-20 wt %, or 10-15 wt %.

Embodiment 11 provides the stabilizer composition of any of embodiments 1-8, wherein the heat-settable material is present in an amount in the range of 15-30 wt %, e.g., 15-25 wt % or 15-20 wt %, or 20-30 wt %.

Embodiment 12 provides the stabilizer composition of any of embodiments 1-11, wherein the starch is granular.

Embodiment 13 provides the stabilizer composition of any of embodiments 1-11, wherein the starch is pre-gelatinized.

Embodiment 14 provides the stabilizer composition of any of embodiments 1-13, wherein the starch is an unmodified starch.

Embodiment 15 provides the stabilizer composition of any of embodiments 1-14, wherein the starch is present in an amount in the range of 25-65 wt %, e.g., 25-60 wt %, or 25-55 wt %, or 25-50 wt %, or 25-45 wt %, or 25-40 wt %.

Embodiment 16 provides the stabilizer composition of any of embodiments 1-14, wherein the starch is present in an amount in the range of 30-70 wt %, e.g., 30-65 wt %, or 30-60 wt %, or 30-55 wt %, or 30-50 wt %, or 30-45 wt %, or 30-40 wt %.

Embodiment 17 provides the stabilizer composition of any of embodiments 1-14, wherein the starch is present in an amount in the range of 35-70 wt %, e.g., 35-65 wt %, or 35-60 wt %, or 35-55 wt %, or 35-50 wt %, or 35-45 wt %.

Embodiment 18 provides the stabilizer composition of any of embodiments 1-14, wherein the starch is present in an amount in the range of 40-70 wt %, e.g., 40-65 wt %, or 40-60 wt %, or 40-55 wt %, or 40-50 wt %.

Embodiment 19 provides the stabilizer composition of any of embodiments 1-14, wherein the starch is present in an amount in the range of 45-70 wt %, e.g., 45-65 wt %, or 45-60 wt %, or 45-55 wt %.

Embodiment 20 provides the stabilizer composition of any of embodiments 1-14, wherein the starch is present in an amount in the range of 50-70 wt %, e.g., 50-65 wt %, or 50-60 wt %.

Embodiment 21 provides the stabilizer composition of any of embodiments 1-20, wherein the plant protein is a legume protein or a nut protein.

Embodiment 22 provides the stabilizer composition of any of embodiments 1-20, wherein the plant protein is bean protein, pea protein, chickpea protein, lentil protein, peanut protein, cashew protein, pulse protein, almond protein, pecan protein, walnut protein, hazelnut protein, or chestnut protein.

Embodiment 23 provides the stabilizer composition of any of embodiments 1-20, wherein the plant protein is a chickpea protein.

Embodiment 24 provides the stabilizer composition of any of embodiments 1-23, wherein the plant protein is present in an amount in the range of 0.1-40 wt %, e.g., 0.1-30 wt %, or 0.1-20 wt %.

Embodiment 25 provides the stabilizer composition of any of embodiments 1-23, wherein the plant protein is present in an amount in the range of 0.1-15 wt %, e.g., 0.1-10 wt %, or 0.1-8 wt %.

Embodiment 26 provides the stabilizer composition of any of embodiments 1-23, wherein the plant protein is present in an amount in the range of 0.5-50 wt %, e.g., 0.5-40 wt %, or 0.5-30 wt %, or 0.5-20 wt %.

Embodiment 27 provides the stabilizer composition of any of embodiments 1-23, wherein the plant protein is present in an amount in the range of 0.5-15 wt %, e.g., 0.5-10 wt %, or 0.5-8 wt %.

Embodiment 28 provides the stabilizer composition of any of embodiments 1-23, wherein the plant protein is present in an amount in the range of 2-50 wt %, e.g., 2-40 wt %, or 2-30 wt %, or 2-20 wt %.

Embodiment 29 provides the stabilizer composition of any of embodiments 1-23, wherein the plant protein is present in an amount in the range of 2-15 wt %, e.g., 2-10 wt %, or 2-8 wt %.

Embodiment 30 provides the stabilizer composition of any of embodiments 1-23, wherein the plant protein is present in an amount in the range of 2-15 wt %, e.g., 2-10 wt %, or 2-8 wt %.

Embodiment 31 provides the stabilizer composition of any of embodiments 1-23, wherein the plant protein is present in an amount in the range of 4-15 wt %, e.g., 4-10 wt %, or 4-8 wt %.

Embodiment 32 provides the stabilizer composition of any of embodiments 1-31, wherein the plant protein is provided in the form of a flour comprising the plant protein.

Embodiment 33 provides the stabilizer composition of embodiment 32, wherein the flour is a chickpea flour.

Embodiment 34 provides the stabilizer composition of embodiment 32 or embodiment 33, wherein the flour is present in an amount in the range of 1-60 wt %, e.g., 1-50 wt %, 1-40 wt %, or 1-30 wt %, or 1-20 wt %.

Embodiment 35 provides the stabilizer composition of embodiment 32 or embodiment 33, wherein the flour is present in an amount in the range of 5-60 wt %, e.g., 5-50 wt %, or 5-40 wt %, or 5-30 wt %, or 5-20 wt %.

Embodiment 36 provides the stabilizer composition of embodiment 32 or embodiment 33, wherein the flour is present in an amount in the range of 10-60 wt %, e.g., 10-50 wt %, or 10-40 wt %, or 10-30 wt %, or 10-20 wt %.

Embodiment 37 provides the stabilizer composition of embodiment 32 or embodiment 33, wherein the flour is present in an amount in the range of 15-60 wt %, e.g., 15-50 wt %, or 15-40 wt %, or 15-30 wt %.

Embodiment 38 provides the stabilizer composition of embodiment 32 or embodiment 33, wherein the flour is present in an amount in the range of 20-60 wt %, e.g., 20-50 wt %, or 20-40 wt %, or 20-30 wt %.

Embodiment 39 provides the stabilizer composition of embodiment 32 or embodiment 33, wherein the flour is present in an amount in the range of 25-50 wt %, or 25-40 wt %, or 25-35 wt %.

Embodiment 40 provides the stabilizer composition of embodiment 32 or embodiment 33, wherein the flour is present in an amount in the range of 30-50 wt %, or 30-45 wt %, or 30-40 wt %.

Embodiment 41 provides the stabilizer composition of embodiment 32 or embodiment 33, wherein the flour is present in an amount in the range of 35-60 wt %, e.g., 35-50 wt %, or 35-45 wt %.

Embodiment 42 provides the stabilizer composition of embodiment 32 or embodiment 33, wherein the flour is present in an amount in the range of 40-60 wt %, e.g., 40-55 wt %, or 40-50 wt %.

Embodiment 43 provides the stabilizer composition of any of embodiments 1-43, wherein the fiber comprises both insoluble fiber and soluble fiber.

Embodiment 44 provides the stabilizer composition of any of embodiments 1-44, wherein at least 30% of the fiber is insoluble fiber, e.g., at least 40%.

Embodiment 45 provides the stabilizer composition of any of embodiments 1-45, wherein the fiber is a citrus fiber.

Embodiment 46 provides the stabilizer composition of any of embodiments 1-46, wherein the fiber is present in an amount in the range of 3-25 wt %, e.g., 3-20 wt %, or 3-15 wt %, or 3-10 wt %.

Embodiment 47 provides the stabilizer composition of any of embodiments 1-46, wherein the fiber is present in an amount in the range of 5-30 wt %, e.g., 5-25 wt %, or 5-20 wt %, or 5-15 wt %, or 5-10 wt %.

Embodiment 48 provides the stabilizer composition of any of embodiments 1-46, wherein the fiber is present in an amount in the range of 10-30 wt %, e.g., 10-25 wt %, or 10-20 wt %, or 10-15 wt %.

Embodiment 49 provides the stabilizer composition of any of embodiments 1-46, wherein the fiber is present in an amount in the range of 15-30 wt %, e.g., 15-25 wt %, or 15-20 wt %.

Embodiment 50 provides the stabilizer composition of any of embodiments 1-49, wherein the total amount of the heat-settable material, the starch, the plant protein and the fiber is at least 60 wt % of the composition, e.g., at least 65 wt % or at least 70 wt %.

Embodiment 51 provides the stabilizer composition of any of embodiments 1-50, wherein the plant protein is provided in the form of a flour, and wherein the total amount of the heat-settable material, the starch, the plant flour and the fiber is at least 80 wt % of the composition, e.g., at least 90 wt % or at least 95 wt %.

Embodiment 52 provides a stabilizer composition according to any of embodiments 1-51, wherein
the heat-settable compound is a hydroxyalkylcellulose;
the plant protein is chickpea protein; and
the fiber is citrus fiber.

Embodiment 53 provides the stabilizer composition according to embodiment 52, wherein the plant protein is chickpea protein provided in the form of chickpea flour.

Embodiment 54 provides the stabilizer composition of embodiment 52 or embodiment 53, wherein the stabilizer composition includes 5-25 wt % hydroxyalkylcellulose (e.g., hydroxypropylmethylcellulose); 25-45 wt % starch; 2-15 wt % chickpea protein; and 5-25 wt % citrus fiber.

Embodiment 55 provides the stabilizer composition of embodiment 52 or embodiment 53, wherein the stabilizer composition includes 10-20 wt % hydroxyalkylcellulose (e.g., hydroxypropylmethylcellulose); 30-40 wt % starch; 4-10 wt % chickpea protein; and 10-20 wt % citrus fiber.

Embodiment 56 provides the stabilizer composition of embodiment 52 or embodiment 53, wherein the chickpea protein is provided in the form of chickpea flour.

Embodiment 57 provides the stabilizer composition of embodiment 56, wherein the stabilizer composition includes 5-25 wt % hydroxyalkylcellulose (e.g., hydroxypropylmethylcellulose); 25-45 wt % starch; 25-45 wt % chickpea flour; and 5-25 wt % citrus fiber.

Embodiment 58 provides the stabilizer composition of embodiment 56, wherein the stabilizer composition includes 10-20 wt % hydroxyalkylcellulose (e.g., hydroxypropylmethylcellulose); 30-40 wt % starch; 30-40 wt % chickpea flour; and 10-20 wt % citrus fiber.

Embodiment 59 provides a food composition suitable for use as a filling or topping, the food composition comprising:
one or more oleaginous components present in an amount in the range of 20-70 wt %;
one or more solid food components present in an amount in the range of 10-45 wt %; a heat-settable material present in an amount in the range of 1-18 wt %;
a starch present in an amount in the range of 6-42 wt %;
a plant protein present in an amount in the range of 0.1-25 wt %; and
fiber comprising insoluble fiber, present in an amount in the range of 1-18 wt %.

Embodiment 60 provides the food composition of embodiment 59, wherein the food composition has a water content of no more than 15 wt %, e.g., no more than 10% or even no more than 5%.

Embodiment 61 provides the food composition of embodiment 59 or embodiment 60, wherein the one or more oleaginous components is present in an amount in the range of 20-60 wt %, or 20-50 wt %, or 20-40 wt %, or 20-30 wt %, or 30-70 wt %, or 30-60 wt %, or 30-50 wt %, or 30-40 wt %, or 40-70 wt %, or 40-60 wt %, or 40-50 wt %, or 50-70 wt %, or 50-60 wt %.

Embodiment 62 provides the food composition of any of embodiments 59-61, wherein the one or more oleaginous components is a liquid at room temperature.

Embodiment 63 provides the food composition of any of embodiments 59-61, wherein the one or more oleaginous components is a solid at room temperature.

Embodiment 64 provides the food composition of any of embodiments 59-63, wherein the one or more oleaginous components comprises palm oil, canola oil, soybean oil, or combinations thereof.

Embodiment 65 provides the food composition of any of embodiments 59-64, wherein the one or more oleaginous components comprises a lecithin such as sunflower lecithin, canola lecithin or soy lecithin.

Embodiment 66 provides the food composition of any of embodiments 59-65, wherein the one or more solid food components is present in an amount in the range of 10-45 wt %, e.g., 10-35 wt %, or 10-25 wt %, or 10-20 wt %, or 15-45 wt %, or 15-35 wt %, or 15-25 wt % or 20-45 wt %, or 20-35 wt %, or 25-45 wt %.

Embodiment 67 provides the food composition of any of embodiments 59-66, wherein the one or more solid food components are selected from the group comprising a cheese powder, a fruit material, or a chocolate powder.

Embodiment 68 provides the food composition of any of embodiments 59-66, wherein the one or more solid food components is a cheese powder.

Embodiment 69 provides the food composition of any of embodiments 59-68, wherein the heat-settable material is as described in any of claims 3-8.

Embodiment 70 provides the food composition of any of embodiments 59-69, wherein the heat-settable material is present in an amount in the range of 1-18 wt %, e.g., 1-15 wt %, or 1-10 wt %, or 1-5 wt %, or 5-18 wt %, or 5-15 wt %, or 5-10 wt %, or 10-18 wt %, or 10-15 wt %.

Embodiment 71 provides the food composition of any of embodiments 59-70, wherein the starch is as described in any of claims 11-14.

Embodiment 72 provides the food composition of any of embodiments 59-71, wherein the starch is present in an amount in the range of 6-42 wt %, e.g., 6-35 wt %, or 6-25 wt %, or 6-18 wt %, or 15-42 wt %, or 15-35 wt %, or 15-25 wt %, or 25-42 wt %, or 25-35 wt %.

Embodiment 73 provides the food composition of any of embodiments 59-72, wherein the plant protein is as described in any of claims 21-23.

Embodiment 74 provides the food composition of any of embodiments 59-73, wherein the plant protein is present in an amount in the range of 0.1-25 wt %, e.g., 0.1-15 wt %, or 0.1-10 wt %, or 0.1-5 wt %, or 0.5-25 wt %, or 0.5-15 wt %, or 0.5-10 wt %, or 0.5-5 wt %, or 2-25 wt %, or 2-15 wt %, or 2-10 wt %, or 2-5 wt %.

Embodiment 75 provides the food composition of any of embodiments 59-74, wherein the plant protein is provided as a plant flour, and wherein the plant flour is present in an amount in the range of 0.5-50 wt %, e.g., 0.5-35 wt %, or 0.5-20 wt %, or 2-50 wt %, or 2-35 wt %, or 2-20 wt %, or 10-50 wt %, or 10-35 wt %, or 10-20 wt %.

Embodiment 76 provides the food composition of any of embodiments 59-75, wherein the fiber is as described in any of claims 43-45.

Embodiment 77 provides the food composition of any of embodiments 59-76, wherein the fiber is present in an amount in the range of 1-18 wt %, e.g., 1-12 wt %, or 1-8 wt %, or 1-4 wt %, or 4-18 wt %, or 4-12 wt %, or 4-8 wt %, or 6-18 wt %, or 6-12 wt %.

Embodiment 78 provides the food composition of any of embodiments 59-77, wherein
the heat-settable compound is hydroxyalkylcellulose;
the plant protein is chickpea protein; and
the fiber is citrus fiber.

Embodiment 79 provides the food composition of embodiment 79, wherein the stabilizer composition includes 5-25 wt % hydroxyalkylcellulose (e.g., hydroxypropylmethylcellulose); 1-9 wt % hydroxyalkylcellulose (e.g., hydroxypropylmethylcellulose); 5-18 wt % starch; 1-5 wt % chickpea protein; and 1-9 wt % citrus fiber.

Embodiment 80 provides the food composition of embodiment 79, wherein the food composition includes 3-7 wt % hydroxyalkylcellulose (e.g., hydroxypropylmethylcellulose); 7-16 wt % starch; 1.5-4 wt % chickpea protein; and 3-7 wt % citrus fiber.

Embodiment 81 provides the food composition of any of embodiments 78-80, wherein the chickpea protein is provided in the form of chickpea flour.

Embodiment 82 provides the food composition of embodiment 81, wherein the food composition includes 1-9 wt % hydroxyalkylcellulose (e.g., hydroxypropylmethylcellulose); 5-18 wt % starch; 5-18 wt % chickpea flour; and 3-7 wt % citrus fiber.

Embodiment 83 provides the food composition of embodiment 81, wherein the food composition includes 3-7 wt % hydroxyalkylcellulose (e.g., hydroxypropylmethylcellulose); 7-16 wt % starch; 7-16 wt % chickpea flour; and 3-7 wt % citrus fiber.

Embodiment 84 provides a food composition suitable for use as a filling or topping, the food composition comprising:
one or more oleaginous components present in an amount in the range of 20-70 wt %:
one or more solid food components present in an amount in the range of 10-45 wt %; and
a stabilizer composition according to any of embodiments 1-58, present in an amount in the range of 20-60 wt %.

Embodiment 85 provides the food composition of embodiment 84, as further described in any of claims 60-68.

Embodiment 86 provides the food composition of embodiment 84 or embodiment 85, wherein the stabilizer composition is present in an amount in the range of 20-55 wt %, or 20-50 wt %, or 20-45 wt %, or 20-40 wt %, or 20-35 wt %, or 25-60 wt %, or 25-55 wt %, or 25-50 wt %, or 25-45 wt %, or 25-40 wt %, or 25-35 wt %, or 30-60 wt %, or 30-55 wt %, or 30-50 wt %, or 30-45 wt %, or 30-40 wt %, or 35-60 wt %, or 35-55 wt %, or 35-50 wt %, or 35-45 wt %, or 40-60 wt %, or 40-55 wt %, or 40-50 wt %.

Embodiment 87 provides the food composition of any of embodiments 59-86, wherein a body of the food composition formed at a 5 mm height does not slump by more than 20% upon baking of the composition at 350° F. for 20 minutes.

Embodiment 88 provides the food composition of any of embodiments 59-87, wherein the food composition as a Bostwick consistency (30 seconds, 23° C.) of 2 to 7 cm.

Embodiment 89 provides a method of making a food composition according to any of embodiments 59-88, comprising:
providing the one or more oleaginous components,
mixing with the one or more oleaginous components the one or more solid food components, the heat-settable material, the starch, the plant protein, and fiber.

Embodiment 90 provides the method according to claim 89, wherein the heat-settable material, the starch, the plant protein, and fiber are provided as a stabilizer composition according to any of embodiments 1-58.

Embodiment 91 provides a method of making filled or topped food item comprising:
providing a uncooked food item comprising an uncooked dough and a food composition according to any of embodiments 59-88 as a filling or topping adjacent to the uncooked dough, and
cooking the uncooked food item, thereby cooking the uncooked dough.

Embodiment 92 provides a method of making a filled snack comprising:
sealing a food composition of any of embodiments 59-88 within an uncooked dough to provide a uncooked food item,
cooking the uncooked food item thereby cooking the uncooked dough.

Embodiment 93 provides a method according to embodiment 92, wherein sealing the food composition within the uncooked dough comprises coextruding the food composition within a tube of the uncooked dough to form an extrudate and cutting the extrudate into uncooked snack pieces, the cutting sealing ends of each uncooked food item.

Embodiment 94 provides the method according to any of embodiments 91-93, wherein the food composition is heated to a temperature in the range of 150-180° F., e.g., 150-170° F., or 150-160° F., or 155-180° F., or 155-170° F., or 155-160° F., or 160-180° F., or 160-170° F., or 165-180° F., or 165-170° F., prior to sealing the food composition within the uncooked dough or disposing the food composition adjacent the uncooked dough.

Embodiment 95 provides the method of any of embodiments 91-94, wherein cooking occurs at a temperature of at least 325° F., e.g., at least 350° F. or at least 375° F.

Embodiment 96 provides the method of any of claims 91-94, wherein cooking occurs at a temperature in the range of 325-400° F., e.g., 350-400° F., or 375-400° F., or 325-375° F., or 325-350° F., or 350-375° F.

Embodiment 97 provides the method of any of embodiments 91-95, wherein the cooking occurs for a time of at least 5 minutes, e.g., at least 8 minutes or at least 10 minutes.

Embodiment 98 provides the method of any of embodiments 91-95, wherein the cooking occurs for a time in the range of 5 to 20 minutes, e.g., 5 to 18 minutes, or 5 to 15 minutes, or 5 to 12 minutes, or 8 to 20 minutes, or 8 to 18 minutes, or 8 to 15 minutes, or 8 to 12 minutes, or 10 to 20 minutes, or 10 to 18 minutes, or 10 to 12 minutes.

Embodiment 99 provides the method of any of embodiments 91-94, wherein cooking occurs at a first temperature for a first amount of time and a second temperature for a second amount of time.

Embodiment 100 provides the method of embodiment 99, wherein the first temperature is in the range of 325-400° F., e.g., 350-400° F., or 375-400° F., or 325-375° F., or 325-350° F., or 350-375° F.

Embodiment 101 provides the method of embodiment 99 or embodiment 100, wherein the first time is in the range of 5 to 20 minutes, e.g., 5 to 18 minutes, or 5 to 15 minutes, or 5 to 12 minutes, or 8 to 20 minutes, or 8 to 18 minutes, or 8 to 15 minutes, or 8 to 12 minutes, or 10 to 20 minutes, or 10 to 18 minutes, or 10 to 12 minutes.

Embodiment 102 provides the method of any of embodiments 99-101, wherein the second temperature is in the range of 200-300° F., e.g., 200-275° F., or 200-250° F., or 225-300° F., or 225-275° F., or 225-250° F., or 250-300° F., or 275-300° F.

Embodiment 103 provides the method of any of embodiments 99-102 wherein the second time is in the range of 15 to 30 minutes, or 15 to 25 minutes, e.g., 15 to 20 minutes, or 20 to 30 minutes, or 20 to 25 minutes, or 25 to 30 minutes.

Embodiment 104 provides the method of any of embodiments 99-103, wherein the first temperature is higher than the second temperature, and the first time is shorter than the second time.

Embodiment 105 provides the method of any of embodiments 91-104, wherein the uncooked dough and the food composition are present in a ratio in the range of 1:5 to 5:1, e.g., 1:3 to 5:1, or 1:2 to 5:1, or 1:1 to 5:1, or 1:5 to 3:1, or 1:3 to 3:1, or 1:2 to 3:1, or 1:1 to 3:1, or 1:5 to 2:1, or 1:3 to 2:1, or 1:2 to 2:1, or 1:1 to 2:1, or 1:5 to 1:1, or 1:3 to 1:1, or 1:2 to 1:1.

Embodiment 106 provides the method of any of embodiments 91-105, wherein the uncooked dough is a pretzel dough.

Embodiment 107 provides the method of any of embodiments 91-105, wherein the uncooked dough is a pastry dough, or a cookie dough, or a cracker dough.

1. A stabilizer composition comprising:
a heat-settable material present in an amount in the range of 5-30 wt %;
starch present in an amount in the range of 25-70 wt %;
a plant protein present in an amount in the range of 0.2-50 wt %; and
fiber comprising insoluble fiber, the fiber being present in an amount in the range of 3-30 wt %.

2. The stabilizer composition of claim 1, in the form of a dry solid.

3. The stabilizer composition of claim 1, wherein the heat-settable material has an inherent moisture content in the range of 1-20 wt %, as measured at equilibrium at 50% relative humidity and 20° C.

4. The stabilizer composition of claim 1, wherein the heat-settable material is a hydroxyalkylcellulose, an alkylcellulose, a carboxycellulose, a heat-settable protein, or a combination thereof.

5. The stabilizer composition of claim 1, wherein the heat-settable material is hydroxypropylmethylcellulose.

6. The stabilizer composition of claim 1, wherein the heat-settable material is present in an amount in the range of 5-25 wt %.

7. The stabilizer composition of claim 1, wherein the starch is present in an amount in the range of 25-65 wt %.

8. The stabilizer composition of claim 1, wherein the plant protein is a legume protein or a nut protein.

9. The stabilizer composition of claim 1, wherein the plant protein is present in an amount in the range of 0.1-40 wt %.

10. The stabilizer composition of claim 1, wherein the plant protein is provided in the form of a flour comprising the plant protein.

11. The stabilizer composition of claim 1, wherein the fiber is a citrus fiber.

12. The stabilizer composition of claim 1, wherein the fiber is present in an amount in the range of 3-25 wt %.

13. The stabilizer composition of claim 1, wherein the total amount of the heat-settable material, the starch, the plant protein and the fiber is at least 60 wt % of the composition.

14. A stabilizer composition according to claim 1, wherein
the heat-settable compound is a hydroxyalkylcellulose;
the plant protein is chickpea protein; and
the fiber is citrus fiber.

15. A food composition suitable for use as a filling or topping, the food composition comprising:
one or more oleaginous components present in an amount in the range of 20-70 wt %;
one or more solid food components present in an amount in the range of 10-45 wt %; and
a stabilizer composition according to claim 1, present in an amount in the range of 20-60 wt %.

16. The food composition of claim 15, wherein the food composition has a water content of no more than 15 wt %.

17. (canceled)

18. The food composition of claim 15, wherein the one or more oleaginous components comprises palm oil, canola oil, soybean oil, lecithin, or a combination thereof.

19. (canceled)

20. The food composition of claim 15, wherein the one or more solid food components are selected from the group comprising a cheese powder, a fruit material, or a chocolate powder.

21. A method of making a food composition according to claim 15, comprising:
providing the one or more oleaginous components,
mixing with the one or more oleaginous components the one or more solid food components, the heat-settable material, the starch, the plant protein, and fiber, wherein the heat-settable material, the starch, the plant protein, and fiber are provided as a stabilizer composition according to claim 1.

22. A method of making a filled snack comprising:
sealing a food composition of claim 15 within an uncooked dough to provide a uncooked food item,
cooking the uncooked food item thereby cooking the uncooked dough.

23. (canceled)

24. (canceled)
